(19) United States
(12) Patent Application Publication
(10) Pub. No.: US 2006/0174009 A1
(43) Pub. Date: Aug. 3, 2006

(54) Method for establishing a multimedia session between a caller device and a receiver device of a multimedia sub-domain type network and a communications system implementing said method

(76) Inventors: Nicolas Martiquet, Paris (FR); Toufic Khalil, Paris (FR); Kim-Anh-Vu Nguyen, Fonteney-Aux-Roses (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/046,480

(22) Filed: Jan. 28, 2005

(30) Foreign Application Priority Data
Jan. 28, 2005 (EP) 04290246.0

(51) Int. Cl. G06F 15/16

(52) U.S. Cl. 709/227

(57) ABSTRACT

A method for establishing a multimedia session between a calling telecommunications equipment and a called equipment that is a mobile equipment of a network of the multimedia sub-domain type, wherein:
an invitation (Invite) is sent from the first user equipment (UE1) to establish a multimedia session, which comprises as he destination address a public identity of the second equipment, said invitation being transmitted:
   by the first equipment (UE1) to a first proxy server (P-CSCF1), then,
   from this first proxy server, to a first session control server (S-CSCF1) of the network in which the first equipment (UE1) is registered, and
   from this first session server (S-CSCF1) to a point of entry server (I-CSCF2) of the network corresponding to the destination address of the second equipment (UE2);
      this point of entry server (I-CSCF2) interrogates a database (HSS2) of the network of the second equipment (UE2) in order to obtain the address of a session control server (S-CSF2) responsible for said second equipment (UE2);
      when said second equipment (UE2) is registered in said database:
         said point of entry server (I-CSCF2) transmits the invitation message to the selected session server (S-CSCF2), and
         said session server (S-CSCF2) transmits the invitation message to a proxy server (P-CSCF2) corresponding to the second equipment, wherein
         the proxy server (P-CSCF2) transmits this invitation message by encapsulating it in an IP packet to the second equipment via an appropriate transit node (GGSN).

The present invention relates to a method for establishing a multimedia session between a caller telecommunications device and a receiving device which is a mobile device of a network supporting the multimedia sub-domain as defined by 3GPP.

This network is advantageously—but non exhaustively—a network of UMTS type.

### 1. GENERAL FIELD OF THE INVENTION: THE INTRODUCTION OF THE MULTIMEDIA SUB-DOMAINE

1.1-Introduction to IMS (IP Multimedia Subsystem”or Multimedia Sub-Domain)

1.1.1-Architecture

The great novelty of version 5 of the 3GPP standard (Release 5) is the introduction of the IP multimedia sub-domain (IP multimedia subsystem—IMS). This sub-domain makes it possible to control the multimedia sessions negotiated end-to-end between two clients on the core network packet defined by 3GPP.

In the following, the method for establishing an incoming multi-media session from a first user's mobile telecommunications equipment UE1 to a second UE2 mobile user telecommunications equipment, implemented using the sub-domain IP multi-media IMS, likewise called hereinafter IP signaling external network or IMS domain, IP meaning of course “Internet protocol”. Otherwise, the mobile operator network to which the client is subscribed is called the “nominal network”.

In this regard, reference is made to the “3GPP TS 23.228 V6.4.1 (2004-01), 3^{rd} Generation Partnership Project; Technical Specification Group Services and System Aspects; IP Multimedia Subsystem (IMS); Stage 2 (Release 6)”, which can be obtained at the URL http://www/3gpp.org/ftp/specs/archive/23 series/23.228/, and to document RFC3261 of the IETF (Working group on the Internet or Internet Engineering Task Force), available at http://www.ietf.org/rfc.

It is assumed that the UE1 equipment is capable of communicating with a first telecommunications network. This UE1 equipment can be any type of equipment, fixed or mobile, supporting the SIP protocol as defined by RFC 3261 and connected to an IP network. It is also assumed more generally that the other UE2 equipment communicates by way of a second network, while knowing, of course, that this could be the same one. The second network is, for example, a packet—switching PS network and is, for example, of the GPRS or UMTS type.

Thus, as illustrated in FIG. 1, the mobile telecommunications network, to which the UE2 equipment is connected, comprises:

transit service nodes which, in the case of GPRS and UMTS, are called GGSN (Gateway GPRS Support Node), which assure passage in the two directions of the data between the network and the IMS IP signaling external network, according to a TCP-IP protocol, for example;

In the case of the GPRS and the UMTS, SGSN service support nodes (Serving GPRS Support Node) which are associated with the base stations and which manage inter alia the mobile communications link serving the equipment UE2 and which ensure the communication between the equipment UE2 and the GGSN transit service node.

The IMS domain makes it possible to control multimedia sessions between the first and the second equipment, UE1 and UE2, and manage call control signaling according to the SIP (Session Initiation Protocol).

The architecture of the IMS domain is based on a certain number of fundamental concepts:
the data plane and the control plane are separate;
the IMS relies entirely on the packet domain (PS, packet switched) in order to ensure its functions;
the IMS domain manages call signal control (SIP) while the PS domain manages access to the network and transport;
existing Internet services can continue to operate without IMS via the GSNs nodes of the packet domain.

1.1.2—The Different Entities of the IMS Domain

Each IMS domain comprises the following entities for implementing the session initiation CSCF (Call Session Control Function):

call session control function proxy servers P-CSCF (Proxy-Call Session Control Function), which are the first points of contact of the user mobile telecommunications equipment UE1, UE2 in the IMS domain for outgoing sessions and play the role of relay between the equipment and the S-CSCF server. Their functions are broadcasting the signaling messages from and to the S-CSCF of the nominal network, handling local emergency calls, allocation of resources during the establishment of the session, compression of the SIP messages to the equipment UE1, UE2, analysis of the addresses or translation of the numbers prior to forwarding requests, generation of the CDRs (Call Data Record, billing information).

session control S-CSCF servers (Serving—Call Session Control Function), which carry out control of the session control and of the services for the equipment UE1, UE2 inasmuch as it is recorded. The S-CSCF server handles and maintains the status of a session. Its principle functions are registration for the user prior to establishment of the sessions, responsibility for the control of the session by processing the call/session signaling coming from the equipment, interaction with the service control area (Service Control Area), which contains the applications of a third-party network of a service provider, retrieval of the user profile stored in a HSS server during the user registration phase, CDR generation.

The interrogation servers I-CSCF (Interrogating—Call Session Control Function), which are the first points of contact of the user mobile telecommunications equipment UE1, UE2 in the IMS domain for incoming sessions. Their main functions are the selection of the control server S-CSCF at the time of the registration procedure, interrogation of the HSS server to obtain the address of the S-CSCF control server under which the user is located, transmission of the SIP messages to the S-CSCF control server, integration of the firewall in order to comply with the security and confidentiality requirements, generation of the CDRs and load sharing between the S-CSCF control servers.

The HSS subscriber server (Home Subscriber Server) or the services subscription database, which is the principle database for a given user and contains the information linked to his or her subscription. In addition to its support of the existing interfaces/functionalities of the nominal network location register HLR (Home Location Register), the HSS database forms an interface with the S-CSCF control servers ad the I-CSCF interrogation servers, and maintains several data, including the user's identification, the security information relevant to that user, the location of the user, the user's profile (services etc.).

1.1.3—Registrationin the IMS Domain

The IMS domain has been designed to enable two users to dynamically establish a multimedia session between the two terminals UE1 and UE2, in order to exchange data, whether in real time or not. Before establishing a multi-media session, the users' equipment must be registered with the IMS domain. This registration makes it possible inter alia for the S-CSCF to be able to contact the user's equipment, when necessary.

It is assumed that the first user equipment UE2 is registered with a first session control server S-CSCF1 of the first IP signaling network IMS.

The different stages having led up to this registration of the IMS domain are, in succession, the following:

attachment and authentication in the first mobile telecommunications network: when a mobile equipment UE2 wants to make use of the network services, it must attach itself to a service support node SGSN1 of the network. In order to do this, the equipment UE2 activates an attachment procedure (GPRS attach), by sending to the service support node SGSN1 a message including the IMSI number of the equipment UE2, this number being called hereinafter IMSI1, the IMSI1 being the IMSI international identification of the mobile subscriber. The node SGSN1 uses this IMSI1 number to recover the data that it will utilize for authenticating the equipment UE2 through an interface Gc at the database HSS2 of the nominal network IMS2. At the end of this procedure, the equipment UE2 is authenticated and attaches to the service support node SGSN1 and its geographic position is recognized, there being a logical association between the equipment UE2 and the service support node SGSN1, the service support node SGSN1 then serving the equipment UE2. The association between the IP address of the node SGSN1 and the IMSI number of UE2 is recorded in the database HSS1 at the time of the procedure attaching the equipment UE2.

activation of a communications channel (PDP Context for Packet Data Protocol Context, which can be translated by context of data exchange in packet mode and which is called hereinafter “communications channel”) this communications channel can be considered as a tunnel enabling the mobile equipment UE2 to transmit data over an external IP network (that is, the Internet). This channel is going to be used for the transmission of the destination signally of the domain IMS2. In order to do this, a novel type of channel has been introduced to make the distinction between the signaling traffic and the data traffic. This channel, the so-called signaling is designated hereinafter by the reference PDP1, is restricted exclusively to signaling and has special service quality characteristics. In order to establish this PDP1 channel, the service support node SGSN1 selects an appropriate transit service node GGSN, hereinafter called GGSN2. The channel PDP1 extends between the nodes SGSN1 and GGSN1 and represents the association between nodes SGSN1 and GGSN1 for UE2, registered in the form of a context PDP. Activation of the channel PDP1 for UE2 activates an IP address for UE2; that is IP1, associated with the nodes SGSN1 and GGSN1.

recognized by the session control proxy server P-CSCF1 and recovery of its IP address by the equipment UE2. Two methods can be used to accomplish this:
the equipment uses a server DHCP (Dyanmic Host Configuration Protocol) in order to obtain the domain name of the P-CSCF2, then a domain names server DNS for retrieving the IP address of said session control proxy server P-CSCF1.
the IP address of a P-CSCF is requested at the time of activation of the channel PDP1. In its reply message, the node GGSN1 sends the IP address of the session control proxy server P-CSCF1 to the equipment UE2.

registration of the mobile equipment UE2 in the nominal network IMS1: the mobile equipment UE2 sends the message SIP required for registering to the proxy server P-CSCF1, said registration message contains the public identity SIP1, the private identity, as well as the identity IP1 of the equipment UE2 and the domain name on the nominal network IMS1. The proxy server P-CSCF1 then registers this identity IP1 of UE2.

The proxy server P-CSCF1 then examines the domain name in order to determine the interrogation server I-CSCF on the nominal network IMS1 and to transmit to it the registration message.

The interrogation server I-CSCF transmits to the database HSS of the nominal network IMS2 a user authorization request message Cx (Cx User Authorization Request message or Cx query) containing the identity (public and private) of the equipment UE2 and the domain name on the nominal network IMS1. The database HSS determines from this Cx query and the subscription data associated with the identity of UE2, if the user of UE2 is already registered and if it is authorized to be registered and sends the corresponding response to the Cx query to the server I-CSCF, said response containing the name of the S-CSCF if it is known to the database HSS. If the response does not contain the name of a S-CSCF, the server I-CSCF sends the public and private identity of UE2 to the database HSS in a selection Cx query (CX Select Pull), in order to ask it for information on the capacities required of the session control server S-CSCF required for said equipment UE2. Using the information provided by the database HSS in the response to this request (Cx Select Pull Resp), the server I-CSCF selects a session control server S-CSCF1 having the required capacities on the nominal network IMS1.

The registration message is then sent from the server I-CSCF to the selected session control server S-CSCF1 with the identifier of the proxy server P-CSCF, the public and private identity of UE2, the contact name on the network visited and, if necessary, the point of contact in the network IMS1. This session control server S-CSCF1 is selected as being capable of ensuring the session control corresponding to the address of UE2. This S-CSCF1 will then control the calls and session of the mobile equipment UE2.

Subsequent to receiving the registration message, the session control server S-CSCF1 sends to the database HSS a Cx server assignment request (SAR, Server Assignment Request or Cx-Put) containing the public and private identities of UE2 and also different types of requests (complete profile request, registration status, etc.). The database HSS then registers, in association, the identifier of the session control server S-CSCF1 and the identity of the equipment UE2, which the session control server S-CSCF1 sent to it. Then the database HSS send to the session control server S-CSCF1, in a server assignment response (SAA, Server Assignment Answer or Cx-Pull Resp), the subscription profile, which corresponds to the identity of the equipment UE2. The session control server S-CSCF1 then registers this profile with identity SIP1 of the equipment UE2 in a registration table. Then an acknowledgement message know as 200 OK is sent by the session control server S-CSCF2 to the equipment UE2 via the servers I-CSCF and P-CSCF2 and the nodes GGSN2 and SGSN2, which means that the registration was successfully made.

At the conclusion of this registration procedure, the proxy server P-CSCF1 knows the IP1 address of the mobile equipment UE2, the server S-CSCF1 knows the proxy server P-CSCF1 on which the mobile equipment UE2 can be met and the mobile equipment UE2 can thus establish or receive a multimedia session.

1.1.4—Identification of the Subscriber

The mobile equipment UE2 has two types of identities relative to the IMS domain: a private identity and one or a plurality of public identities.

The private identity is unique to each user, is not used for routing messages SIP, is granted permanently, serves to identify the user information on the subscriber server HSS, serves to authenticate the user during his/her registration, is defined by the operator of the nominal network and is registered on the subscriber server HSS and the server S-CSCF1 for each equipment registered. The private identity can, for example, include the international identity IMSI of the mobile subscriber, which is its identification number on the first network.

The public identity has the format of a SIP address URL (in the SIP form: user@domain.net), which is assumed to be the case hereinafter or a telephone number E.164. Several public identifies are possible for one user. These identities are not used for authentication during registration but are utilized for routing messages in the domain IMS. These public identities are registered in the database HSS in association with the private identity.

Having been registered in advance, the first equipment UE2 thus has an SIP address, hereinafter called SIP1 and the IP1 address, which are registered in association in the database HSS and on the session control server S-CSCF1.

1.1.5—Example of Establishment of an IMS Session between Two Subscribers

FIG. 2 illustrates the establishment of a session between two subscribers belonging to the same network.

The procedure can be described by the following steps:
1. In order to be able to establish a session with UE2, after its registration with the domain IMS, UE1 sends the SIP message “invite” (addressed to the public identity of UE2) to the P-CSCF1 of the network visited, where he is roaming;
2. When the P-CSCF1 receives the invite message, it transmits it to the S-CSCF1 where UE1 is registered;
3. On resolving the domain name sent in the invite message, the S-CSCF1 transmits the invite message to an I-CSCF2 of the network of the equipment UE2;
4. The I-CSCF2 interrogates the HSS in order to determine the address of the S-CSCF responsible for UE2 and then transmits the invite message to the S-CSCF2;
5. This S-CSCF2 can request service control and then routes the invite message to the corresponding P-CSCF2 according to the information stored on the S-CSCF2 during registration of UE2.
6. The P-CSCF2 transmits the invite message to the IP address of the UE2 stored during registration of UE2;
7. After the UE2 has received the invite message coming from the UE1, several SIP messages are exchanged between these two equipment via the different CSCFs, in order to ensure the establishment of the IMS session. During this phase, the two UEs negotiate the different parameters of the IMS session and when UE2 receives the message ACK from the UE1 indicating the confirmation of opening of a new session, the two UEs can exchange data. If one of the UEs wishes to terminate the session, it sends the message BYE to the other UE and the session will be terminated.

### 2. PRESENATION OF THE PRIOR ART

2.1 Case of an Incoming Multimedia Session: “PDP Conext “Always On””

In the most recent version of the standard (Release 5), if a terminal does not have an active data packet protocol (“PDP Context” active) to the IMS, then the mobile device cannot be connected and cannot receive incoming sessions, because no mechanism has been defined to enable activation of a PDP context by the network. In fact, currently the only means provided for correctly starting the incoming multimedia sessions is to have a signaling PDP context called “Always On” for exchanging signals between the mobile device and the IMS.

An “Always On” PDP context is a PDP context that remains activated permanently even if it is not used. However, this PDP context can be, if necessary, deactivated at any time by the mobile device or the network.

Utilization of the “Always On” signaling PDP context in the case of the IMS in order to satisfactorily route the incoming multimedia sessions provides several advantages:
minimum delay for establishing the incoming multimedia session;
the mobile device is always connected to the IMS and is ready to exchange signaling;
less signaling over the equipment at the core of the network;
more rapid access to the services platforms;
a simple, uncomplex solution for incoming services (“Push Services”).

However, utilization of the “Always On” signaling PDPs contexts also has some drawbacks:
consumption of storage capacity and handling of the PDP contexts in the entities of the core network (GSNs);
consumption of the network resources (IP address);
impacts on billing;
impacts on the roaming situations.

Accordingly, despite all of the benefits of utilizing the “Always On” PDP context, this method presents numerous drawbacks for network operators, principally because of the high consumption of storage capacity and handling capacity of PDP contexts in the GSNs of the core network. In fact, the storage capacity of the GSNs in number of simultaneous PDP contexts as a major constraint. The solution of increasing the number of GSNs is very costly for operators.

2.1 The Activation of PDP Context in the Case of the GPRS

2.1.1 The “Push Proxy” Solutionproposed by RIM

Among the solutions proposed in the case of GPRS for activation of a PDP context at the initiative of the network, one attractive solution is NRPCA (Network Requested PDP Context Activation). This solution has been proposed by RIM (Research in Motion) to 3GPP in the context of elaboration of the TR 23.976, whose aspects of interest to the present invention are already described in TR 23.974 (which was never approved by the 3GPP, TR 23.976 is in process of elaboration).

The solution proposed by RIM is based on the utilization of a Push Proxy in the operator network that interfaces between the entity that initiates the Push message and the GPRS core network of the operator. An Address Resolver, also situated in the operator network, makes it possible for the Push Proxy to make the connection between the public identifier received from the outside and the corresponding network identifier for the targeted terminal. The Push Proxy also identifies if the client already has an active PDP context and it filters the queries in order to prevent the GGSN from being accosted by an uncontrolled flow.

2.1.2 Introduction to “Push Proxy” and “Push Initiator”

In order to enable incoming service, the operator's network includes a “Push Proxy”, whilst the “Push Initiator” is typically on an external network like the Internet. The Push Initiator initiates the service incoming into the external network and sends the corresponding packets to the Push Proxy in the mobile operator's network. Then the Push Proxy transmits the query to the packet core network and to the UE. The Push Proxy function also includes filtering capabilities in order to prevent unauthorized Push Initiators from being able to attack the packet core network of the mobile operator and the packet core network of the mobile operator. This implies that, in this model, the UE trusts the Push Proxy that is will not send it undesired incoming packets.

2.1.1 The RIM Solution does not Translate directly to the IMS

The application to the IMS of RIM's NRPCA is not direct in the case, where the client is not registered with the IMS; in fact, the following functions are specific to the IMS and are thus not described by RIM:
the choice of the P-CSCF by the S-CSCF;
the choice of the GGSN by the P-CSCF;
the link between the P-CSCF and the Address Resolver; in fact, no interface is provided between these two entities, which necessitates a specific behavior of the P-CSCF and of the GGSN.

### 3. STATEMENT OF THE INVENTION

The introduction of the sub-domain IP multimedia (IP Multimedia Subsystem—IMS) by the aforementioned 3GPP standardization documents opens the way to novel multimedia and real-time applications. In fact, the operators of mobile networks can, thanks to IMS, provide clients with a wide range of novel advanced services, which create new commercial opportunities.

A general object of the invention is to propose an IMS solution that makes it possible to resolve the different problems of the “Always On” PDP contexts and is otherwise less costly.

In particular, the solution proposed makes it possible to provide novel services less expensively in terms of network resources and thus in terms of deployment costs.

In particular, a solution is proposed that allows activation of a signaling PDP context alone when necessary (for example, in the case of an incoming multimedia session) instead of having a constantly activated signaling PDP context.

Thus, the NRPCA solution proposed by RIM is adapted in the context of the IMS.

The NRPCA solutions adapted for application to the IMS makes it possible for a client not having an active signaling PDP context to be able to receive and establish incoming multimedia sessions. This is possible, because this solution allows an entity of the network to be capable of detecting a situation wherein there is an incoming IMS for a certain client and thus initiate a signaling PDP context activation query by mobile device.

The advantages of this solution for incoming multimedia sessions are the following:
it is not necessary to have a constantly active signaling PDP context;
low consumption of network resources (IP addresses, GSN capacities);
an entity of the network (P-CSCF) controls the initiation of a session.

More precisely, it a method is proposed for establishing a multimedia session between a calling telecommunications equipment and a called equipment that is a mobile device of a network of the multimedia sub-domain type, wherein:
an invitation (invite) to establish a multimedia session is issued from the first user equipment (UE1), which comprises as the destination address a public identity of the second equipment, said invitation being transmitted:
   by the first equipment (UE1) to a first proxy server (P-CSF1), then,
   from this first proxy server, to a first session control server (S-CSF1) for the network, in which the first equipment (UE1) is registered, and
   from this first session server (S-CSF1), to a entry point server (I-CSCF2) of the network corresponding to the destination address of the second equipment (UE2);
this point of entry server (I-CSCF2) interrogates a database (HSS2) of the network of the second equipment (UE2) in order to obtain the address of a session control server (S-CSF2), responsible for said second equipment (UE2);
when said second equipment (UE2) is registered in said database,
   said point-of-entry server (I-CSCF2) transmits the invitation message to the selected session server (S-CSCF2) and
   said session server (S-CSCF2) transmits the invitation message to a proxy server (P-CSCF2) corresponding to the second equipment:
wherein:
   the proxy server (P-CSCF2) transmits said invitation message, by encapsulating it in an IP packet, to the second equipment via an appropriate transit node (GGSN).
According to one embodiment:
   The transit node (GGSN) interrogates an address resolution (AR) database, in order to convert the public identity of the second equipment into an international subscriber identification number (IMSI) and in order to determine as a function of this identification number (IMSI) the address of a service node (SGSN) serving said second equipment (UE2);
   The transit node (GGSN) transmits a signaling PDP context activation query to said service node, on which the second equipment (SGSN) depends, for activation of the multimedia communication channel;
   Said service node (SGSN), on which the second equipment depends, sends said request to the second equipment (UE2).

This method can be complemented by the following features, taken alone or in any technically feasible combination thereof:
when the point-of-entry server (I-CSCF2) queries the database (HSS2) of the network of the second equipment in order to determine the session control server (S-CSCF2) responsible for same and when the public identity of said second equipment (UE2) is not registered in said database, said point-of-entry server (I-CSCF2) selects a session control server from among a plurality of possible servers and transmits to it the invitation message;
the second server (S-CSCF2) is registered on the database as being the session control server associated with the second mobile equipment;
when the second session control server (S-CSCF2) receives the invitation message and when the database (HSS2) does not contain any correspondence between the public identity of the second equipment and an address on the network, the session control server selects a proxy server from among a plurality of possible servers;
when the second proxy server (P-CSCF2) receives the invitation message and when the database (HSS2) does not contain a correspondence between the public identity of the second equipment and an address on the network, said proxy server (P-CSCF2) then selects a transit node (GGSN) on the network of the second equipment in order to transmit to it the IP packet by giving it a specific address corresponding to that node;
the specific address is that of the address resolution database;
when the transit node (GGSN) receives this IP packet and detects this specific address, it interrogates an address resolution database (AR) in order to obtain the international subscriber identification number (IMSI) of the second equipment depending on the call control signaling identity (SIP) transmitted with the invitation message,
said transit node (GGSN) interrogating the database of the network (HSS2) in order to determine as a function of this identification number (IMSI) the address of the service node (SGSN) serving said second equipment (UE2);
the transit node (GGSN) transmits to said service node, on which the second equipment (SGSN) depends, a signaling PDP context activation query for activation of the multimedia communications channel;
said service node (SGSN), on which the second equipment depends, sends this query to the second equipment (UE2);
when the address resolution database receives the IP packet, it sends to the transit node (GGSN) which corresponds to it, the international subscriber identification code (IMSI) of the second equipment, which depends on the call control signaling identity (SIP) transmitted with the invitation message,
   said transit node (GGSN) interrogating the database of the network (HSS2) in order to determine, depending on this identification number (IMSI), the address of the service node (SGSN) serving said second equipment (UE2);
   the transit node (GGSN) transmits to said service node, on which the second equipment (SGSN) depends, a signaling query (PDP context) for activation of the multimedia communications channel;
   said service node (SGSN), on which the second equipment depends, sends this query to the second equipment (UE2);
According to one possible embodiment:
   the second equipment (UE2) activates, with a transit node that may be different from the first transit node, a multimedia communications procedure corresponding to the query, which it received;
and wherein,
   the second equipment (UE2) pursues the procedure by discovering a proxy server (P-CSCF2′), possibly corresponding to the second proxy server, then by registering again on the second session control server (S-CSCF2), this latter verifying the acknowledgement of the invitation messages at the destination of the second equipment (UE2) and re-transmitting any invitation message not acknowledged at the second equipment (UE2) conforming to the most recent registration received and by requesting the former second proxy server (P-CSF2) to cancel any query in progress.

Furthermore, the invention relates to a system of communication enabling the establishment of a multimedia session between a calling telecommunications equipment and a called equipment which is a mobile equipment of a multimedia sub-domain type network, wherein the calling or called equipment(s) and/or the proxy server(s) and/or the session server(s) and/or the point-of-entry server(s) and/or the service nodes comprise the processing means for implementing the aforementioned method.

In fact, in one embodiment, the network comprises at least one session control server that comprises the memory means in which the addresses of the proxy servers are stored.

### 4. DESCRIPTION OF THE FIGURES

The invention will be better understood upon a reading of the description that follows and provided solely by way of example and non-limiting, with reference to the appended figures, wherein:

FIG. 1 diagrammatically represents an IMS architecture;

FIG. 2 represents the establishment of an IMS session between two subscribers of the same operator;

FIG. 3 and FIG. 4 represent two possible embodiments of the invention.

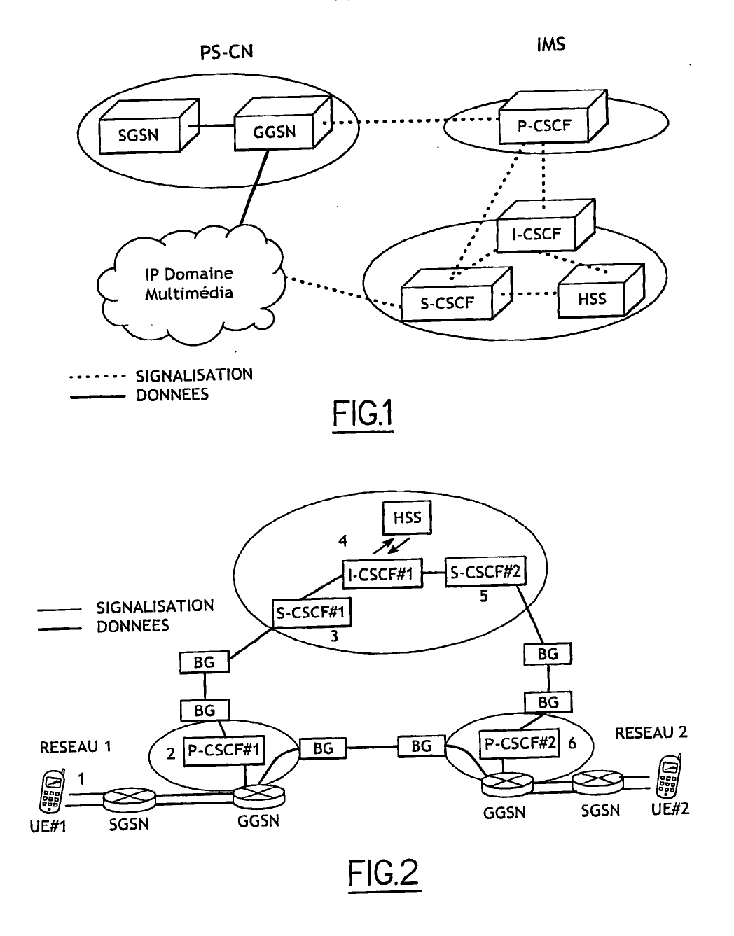

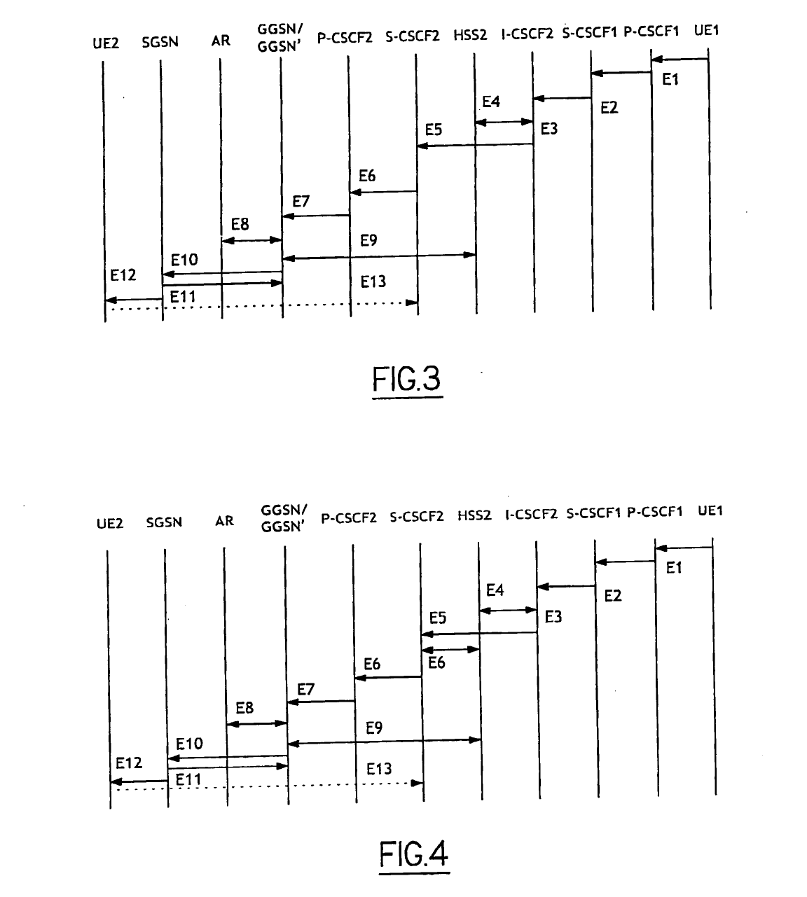

### 5. DESCRIPTION OF SEVERAL EMBODIMENTS OF THE INVENTION

5.1 Mobile Device Registered with the IMS but Not Have Active PDP Context

It is assumed here that the mobile telecommunications equipment UE2 of the other user, with which the mobile telecommunications equipment UE1 wishes to establish a session, is registered with the IMS domain according to the same procedure hereinbefore described for UE1 but no longer has the signaling communication channel (PDP context) established between a node SGSN and node GGSN of the second network 2 between UE2 and the IMS2 domain.

Given that the equipment UE2 is registered with the domain IMS2,
this equipment UE2 has already obtained an associated IP address (or IP2 in the following) and an associated SIP address (or SIP2 in the following) that are registered in association in the database HSS2 and on the session control server S-CSCF2 of the domain IMS2;
the identifier of the session control proxy server P-CSCF2 of the domain IMS2 that serves the equipment UE2 is known to the session control server S-CSCF2, in association with its addresses SIP2, IP2;
the identifier of the session control server S-CSCF2 that serves the equipment UE2 is known to the subscriber server HSS2, in association with its addresses SIP2, IP2;

Given that the equipment UE2 is connected to the mobile operator's network;
The IP address of the node SGSN that serves the equipment UE2 on the second network is know to the base HSS2, this node being designated as SGSN2.

This equipment UE2 has in addition an IMSI number, designated hereinafter as IMSI2, registered in HSS2, in association with its IP2, SIP2.

The first equipment UE1 emits an invitation to establish an incoming session, which comprises a destination address (Invite), a first field (Via) listing the addresses of the entities through which the invitation passes, a destination address (To), a second field (Contact) for the address to contact on return of the invitation, which are those indicated below. The purpose of the Via field is to prevent routing loops and to ensure that the response messages from the same connection follow the same route. This invitation is a SIP message. This invitation is, for example, the one illustrated below.

| | |
|---|---|
| Invite | Public identity SIP2 of |
| sip:user2_Public@home2.net SIP/2.0 | called entity UE2 |
| Via: SIP/2.0/UDP | IP1 address of calling |
| [5555::aaa:bbb:ccc:ddd]:1357 | entity UE1 |
| From: <sip:user1_Public@home1.net> | Public identity SIP1 of |
| | calling entity UE1 |
| To: <user2_Public@home2.net> | Public identity SIP2 of |
| | called entity UE2 |
| Contact: | IP1 address of calling |
| <SIP;[5555::aaa:bbb:ccc:ddd]:1357> | entity UE1 to contact on |
| | return |

Obviously, the public identity of the equipment UE2 could also be its international number E.164.

During a first step E1, the invitation is sent to the proxy server P-CSCF1 by the established PDP1 channel, via the nodes associated with UE1 that are SGSN1 and GGSN1.

Then, during the step E2, the proxy server P-CSCF1 transmits the invitation indicated below to the session control server S-CSCF1, where the equipment UE1 is registered according to the foregoing.

In order to do this, the proxy server P-CSCF1 adds its address in the Record—Route field (or registration route) of the invitation, so that all of the messages belonging to the session pass through it. When an entity wishes that all of the messages of one and the same communication pass through it, it adds its name in the Record—Route header.

| | |
|---|---|
| Invite | Public identity SIP2 of |
| sip:user2_Public@home2.net SIP/2.0 | the called entity UE2 |
| Via: SIP/2.0/UDP pcscf1.visted.net, | Address of the P-CSCF1, |
| SIP/2.0/UDP | IP1 address of the |
| [5555::aaa;bbb;ccc;ddd]:1357 | calling entity UE1 |
| From: <sip:user1_Public@home1.net> | Public identity SIP1 of |
| | the calling entity UE1 |
| To: <user2_Public@home2.net> | Public identity SIP2 of |
| | the called entity UE2 |
| Contact: | IP1 address of the |
| <SIP;[5555::aaa:bbb:ccc:ddd]:1357> | calling entity UE1 to |
| | contact on return |
| Record - Route: <sip:pcsf1.visited.net> | Address of the P-CSCF1 |

During the following step E3, the server S-CSCF1 determines, by resolving the domain name of the destination SIP2 address (To), the point-of-entry into the nominal network IMS2 of the equipment UE2; that is, the interrogation server I-CSCF of the network IMS2, designated hereinafter by the reference I-CSCF2. Then the server S-CSCF1 transmits the invitation represented below to this server I-CSCF2.

| | |
|---|---|
| Invite | Public identity SIP2 of |
| sip:user2_Public@home2.net SIP/2.0 | called entity UE2 |
| Via: | IP1 address of calling |
| SIP/2.0/UDP scscf1.home1.net, | entity UE1 |
| SIP/2.0/UDP pcsf1.visited.net, | |
| SIP/2.0/UDP | |
| [5555::aaa:bbb:ccc:ddd]:1357 | |
| From: <sip:user1_Public@home1.net> | Public identity SIP1 of |
| | calling entity UE1 |
| To: <user2_Public@home2.net> | Public identity SIP2 of |
| | called entity UE2 |
| Contact: | IP1 address of calling |
| <SIP;[5555::aaa:bbb:ccc:ddd]:1357> | entity UE1 to contact |
| | on return |
| Record - Route: | |
| <sip:scsf1.home1.net> | Address of the S-CSCF1, |
| <sip:pcsf1.visited.net> | Address of the P-CSCF1 |

During the following step E4, the interrogation server I-CSCF2 requests the subscription database HSS2 of the nominal network 2, using the public identity of equipment UE2 present in the destination address (To), which is the address of the session control server S-CSCF of the nominal network 2, which is responsible for the equipment UE2 having this public identity.

As the second equipment UE2 is already registered the database HSS2 responds to the server I-CSCF2 with the address of the appropriate control server S-CSCF2 of the nominal network IMS2, said control server S-CSCF2 having been selected in advance at the time of registration of UE2 as being capable of ensuring the session control corresponding to the address of UE2.

In the following step E5, the interrogation server I-CSCF2 routes the invitation represented below to the control server S-CSCF2 corresponding to this address provided by the database HSS2.

| | |
|---|---|
| Invite | Public identity SIP2 of |
| sip:user2_Public@home2.net SIP/2.0 | called entity UE2 |
| Via: | |
| SIP/2.0/UDP icscf2.home2.net, | Address of the I-CSCF2, |
| SIP/2.0/UDP scscf1.home1.net, | Address of the S-CSCF1, |
| SIP/2.0/UDP pcsf1.visited.net, | Address of the P-CSCF1, |
| SIP/2.0/UDP | IP1 address of the |
| [5555::aaa:bbb:ccc:ddd]:1357 | calling entity UE1 |
| From: <sip:user1_Public@home1.net> | Public identity SIP1 of |
| | calling party UE1 |
| To: <user2_Public@home2.net> | Public identity SIP2 of |
| | called party UE2 |
| Contact: | IP address1 of calling |
| <SIP;[5555::aaa:bbb:ccc:ddd]:1357> | entity UE1 to contact |
| | on return |
| Record - Route: | |
| <sip:scsf1.home1.net> | Address of the S-CSCF1, |
| <sip:pcsf1.visited.net> | Address of the P-CSCF1 |

The second equipment UE2 being registered in the second nominal network IMS2, the control server S-CSCF2 has already stored the IP2 address of UE2 and its next associated server CSCF, which is the proxy server P-CSCF2, during the registration procedure.

At step E6 following step E5, the control server S-CSCF2 transmits the invitation represented below to this proxy server P-CSCF2, by introducing the IP2 address of UE2 in place of its SIP2 address in the invite field. The invitation received at the time of step E5 by the control server S-CSCF2 is stored in it in association with the identity SIP2.

| | |
|---|---|
| Invite | Public identity IP2 of |
| sip:[5555::eee:fff:ggg:hhh]:1357> | called entity UE2 |
| SIP/2.0 | |
| Via: | |
| SIP/2.0/UDP scscf2.home2.net, | Address of the S-CSCF2, |
| SIP/2.0/UDP icscf2.home2.net, | Address of the I-CSCF2, |
| SIP/2.0/UDP scscf1.home1.net, | Address of the S-CSCF1, |
| SIP/2.0/UDP pcsf1.visited.net, | Address of the P-CSCF1, |
| SIP/2.0/UDP | IP1 address of the |
| [5555::aaa:bbb:ccc:ddd]:1357 | calling entity UE1 |
| From: | Public identity SIP1 of |
| <sip:user1_Public@home1.net> | calling party UE1 |
| To: <user2_Public@home2.net> | Public identity SIP2 of |
| | called party UE2 |
| Contact: | IP1 address of calling |
| <SIP;[5555::aaa:bbb:ccc:ddd]:1357> | entity UE1 to contact on |
| | return |
| Record - Route: | |
| <sip:scsf2.home2.net> | Address of the S-CSCF2, |
| <sip:scsf1.home1.net> | Address of the S-CSCF1, |
| <sip:pcsf1.visited.net> | Address of the P-CSCF1 |

When the proxy server P-CSCF2 receives the invitation, it, as illustrated below, is encapsulated at step E7 in an IP packet whose IP header has, as its destination IP address, the one present in the Invite field of the invitation; that is, the IP2 address of UE2. The proxy server P-CSCF2 sends this invitation in this packet to a node GGSN2 of any transit service of the mobile telecommunications network 2 associated with UE2, but determined as being appropriate. The proxy servers P-CSCF are configured in advance for sending the invitations that they receive to any one in a list of transit service nodes GGSN determined in advance by the network as supporting the signaling communications channel activation (signaling Context PDP) In order achieve this, the transit service nodes GGSN of this list are those of a sufficiently evolved version such as version 5, for example.

| | |
|---|---|
| Invite | Public identity IP2 of |
| sip:[5555::eee:fff:ggg:hhh]:1357> | called entity UE2 |
| SIP/2.0 | |
| Via: | |
| SIP/2.0/UDP pcscf2.visited1.net, | Address of the P-CSCF2, |
| SIP/2.0/UDP scscf2.home2.net, | Address of the S-CSCF2, |
| SIP/2.0/UDP icscf2.home2.net, | Address of the I-CSCF2, |
| SIP/2.0/UDP scscf1.home1.net, | Address of the S-CSCF1, |
| SIP/2.0/UDP pcsf1.visited.net, | Address of the P-CSCF1, |
| SIP/2.0/UDP | IP address1 of the |
| [5555::aaa:bbb:ccc:ddd]:1357 | calling entity UE1 |
| From: <sip:user1_Public@home1.net> | Public identity SIP1 of |
| | calling party UE1 |
| To: <user2_Public@home2.net> | Public identity SIP2 of |
| | called party UE2 |
| Contact: | IP1 address of calling |
| <SIP;[5555::aaa:bbb:ccc:ddd]:1357> | entity UE1 to contact on |
| | return |
| Record - Route: | |
| <sip:pcsf2.visited1.net> | Address of the P-CSCF2, |
| <sip:scsf2.home2.net> | Address of the S-CSCF2, |
| <sip:scsf1.home1.net> | Address of the S-CSCF1, |
| <sip:pcsf1.visited.net> | Address of the P-CSCF1 |

The second transit service node GGSN2 of the second external mobile telecommunications network 2 examines in the following step E8 if there exists a second communications channel (PDP Context) between it and a node SGSN of the second mobile telecommunications network 2 for the IP2 address coming from the header IP of the packet encapsulating the invitation. Given that no communication channel (Context PDP) exists for the second equipment UE2 in this network 2 (vide supra), the node GGSN2 confirms it. This confirmation results in the transit service node GGSN2:

extracts from the IP packet received, the IP address of the header of the packet, which is that IP2 of UE2;

interrogates an address resolution module AR in order to inquire what the IMSI number is corresponding to the IP2 address extracted.

This address resolution module AR is present in the visited mobile telecommunications network 2 associated with the second equipment UE2 and is functionally distinct from the subscription services database HSS2. Registered permanently in association with the public addresses (at least those IP and possibly those SIP) mobile telecommunications equipments of the second network 2 and their private identity, and thus the public IP2 address and the number IMSI2, associated with the second equipment UE2 are in this address resolution module AR. When the signaling communications channel (signaling PDP context) is suppressed between the equipment UE2 and a node GGSN of the associated mobile telecommunications network 2, the public identities of this equipment UE2, such as its IP address and its SIP address are not deleted from the resolution module AR.

The module AR having received the interrogation from the node GGSN2, it sends to this latter the number IMSI associated with the IP2 address present in this interrogation; that is, the number IMSI2.

At the following step E9, the second transit service node GGSN2 requests from the subscription database HSS2, via an interface Gc, the IP address of the SGSN service support node of the second mobile telecommunications network that serves the equipment UE2 having the IMSI2 identification number. The subscription database HSS2 then answers the second transit service node GGSN2, via Gc, using the IP address of the service support node SGSN2 in the second mobile telecommunication network 2 serving the UE2 equipment having identification number IMSI2, the association between this IP address of the node SGSN2 and the number IMSI2 being pre-registered in the database HSS2 at the time of the advance attachment procedure of the equipment UE2. The step E9 is carried out with the MAP procedures.

Then, at the time of step E10, the second transit service node GGSN2 sends to the IP address of said node SGSN2, having communicated with it in step E9, a notification of incoming packet by stating that it is a signaling communications channel (signaling PDP context), said notification being, for example, a PDU notification message (PDU notification request, PDU meaning Protocol Data Unit). This PDU notification message contains the number IMSI2 of UE2, the IP2 address of UE2, the name of the corresponding point of access APN (Access Point Name) and the field IMCN Subsystem Signaling Flag (IP Multimedia Core Network Subsystem Signaling Flag) of the parameter PCO (Protocol Configuration Option) set to one in order to indicate that it is a signaling channel.

At the following step E11, the service support node SGSN2 sends to the transit service node GGSN2 a response to the notification of incoming packet, in order to inform it that the operation is continuing, this response being a notification response message PDU (PDU Notification Response).

At the following step E12, the service support node SGSN2 asks the second equipment UE2 to request (“Request PDP context activation”) a signaling communication channel activation (signaling PDP context).

At the following step E13, the second equipment UE2 is registered with the nominal network IMS2 in the following fashion.

The second equipment UE2 activates, by using its IP2 address already assigned, a signaling communications channel (PDP context for signaling), designated using the reference PDP2, of the service support node SGSN2, having sent it the activation request and to which the second equipment has been attached, to a transit service node GGSN of the second mobile telecommunications network 2, which can be different or identical to the node GGSN2 and which is designated by the reference GGSN2bis.

Then the discovery procedure of the session control proxy server P-CSCF of the second nominal network IMS2, described hereinbefore for UE1, is used for UE2 suing the transit service node GGSN2bis of the second mobile telecommunications network 2, which concludes with the discovery of a session control proxy server P-CSCF2bis of the second nominal network IMS2, identical to or different from the session control proxy server P-CSCF2 of the second nominal network IMS2.

Then, the re-registration procedure of the second equipment UE2 is implemented in a second nominal network IMS2 by utilizing the identity of UE2. It being given that the subscription database HSS2 of the second nominal network IMS2 registered, at the time of prior registration of UE2 (vide supra), the identifier of the session control server S-CSCF2 serving this equipment UE2 in association with its public identity SIP2, the request for re-registration is automatically transmitted to this same session control server S-CSCF2 of the second nominal network IMS2. As a result, the second equipment UE2 will be re-registered by its identity or identities, according to the registration procedure described hereinbefore, in the second nominal network IMS2 in the database HSS2 of the session control server S-CSCF2, which then registers—as re-send proxy server P-CSCF—the session control proxy server P-CSCF2bis, which knows the IP2 address of the second equipment UE2 by having registered it.

When it receives this re-registration request, the session control server S-CSCF2 checks whether the identity SIP2 of the second equipment UE2 present in the re-registration request is also present in it registration table. It being given that the second equipment UE2 is already recorded in that session control server S-CSCF2, the SIP2 address of this second equipment UE2 is already registered in the registration table of the session control server S-CSCF2 and, consequently, the result of the check is that the identity SiP2 of the second equipment UE2 is present in the request for re-registration is also present in its registration table. This result cause the session control server S-CSCF2 to examine if there is an invitation that it has kept stored at step E6 for the identity SIP2 of the second equipment UE2, present in the request for re-registration and if, for this stored invitation, the session control server S-CSCF2 has not received an OK message from the second equipment UE2. If this is the case, the session control server S-CSCF2 re-sends the stored invitation to the second equipment UE2 by following the characteristics obtained at the time of the last registration procedure, via the transit service node P-CSCF2bis, the service node GGSN2bis and the service support node SGSN2.

The session will then be established.

5.2 Mobile Device not Registered in the IMS

It is assumed that the mobile communication equipment UE2 of the other user, with which the mobile telecommunications equipment UE1 wishes to establish a session, is not registered with the domain IMS and does not have a signaling communications channel (PDP context) established between a node SGSN and a node GGSN of the second network 2 between UE2 and the domain IMS2.

It being given that the equipment UE2 is not registered with the domain IMS2:
this equipment UE2 does not necessarily have an IP address known in the database HSS2 and in the session control servers S-CSCF of the domain IMS2;
no session control proxy server P-CSCF identifier of the domain IMS2 that serves the equipment UE2 is known to the session control servers S-CSCF of the domain IMS2;
no session control server S-CSCF identifier of the domain IMS2 that serves the equipment UE2 is know to the subscription database HSS2.

The second equipment UE2 is not registered but has subscribed to services with the services subscription database HSS2 of the domain IMS2, to which this second equipment UE2 is connected in accordance with the attachment and authentication procedure. The second equipment UE2 thus has services and a user profile in the subscription database HSS2, which are known in association with the non-registered status and the public identity SIP2 of the second equipment UE2. The procedure relative to the non-registered status is described, for example, by the 3GPP TS 23.228 V5.8.0 document mentioned above, of which section 5.12 is included by reference herein. The IP address of the node SGSN2 serving the equipment UE2 in the second network 2 is thus known in the database HSS2 (it is assumed that the equipment UE2 has carried out the radio attachment procedure).

In addition, the equipment UE2 has a number IMSI, hereinafter called IMSI2, registered in HSS2.

The procedure described hereinafter is represented in FIG. 4.

In the second embodiment, steps E1, E2, E3 described hereinbefore are carried out.

After step E3, the interrogation server I-CSCF2 queries during the following step E4, the subscription database HSS2 o the nominal network 2, using the public identity of the equipment UE2 present in the destination address (To), which is the address of the session control server S-CSCF of the nominal network 12, which is responsible for the equipment UE2 having this public identity; that is, public identity SIP2.

The database HSS2 responds to the interrogation server I-CSCF2 by selecting an appropriate control server S-CSCF of the nominal network IMS2; that is, corresponding to the services data (for example “Push”) subscribed to by the second equipment UE2 in the database HSS2 in association with its public identity SIP2.

Then, at step E5, the interrogation server I-CSCF2 selects, according to the characteristics of the control server S-CSCF received at step E4 from the database HSS2, a control server S-CSCF respective of the characteristics in the nominal network IMS2, or the session control server S-CSCF2bis, which will then be ale to ensure the session control corresponding to the address of UE2. The interrogation server I-CSCF2 determines the address of the control server S-CSCF2bis and transits to it the invitation represented below.

| | |
|---|---|
| Invite sip: | Public identity SIP2 of |
| user2_Public@home2.net SIP/2.0 | called entity UE2 |
| Via: | |
| SIP/2.0/UDP icscf2.home2.net, | Address of the I-CSCF2, |
| SIP/2.0/UDP scscf1.home1.net, | Address of the S-CSCF1, |
| SIP/2.0/UDP pcscf1.visited.net, | Address of the P-CSCF1, |
| SIP/2.0/UDP | IP1 address of the |
| [5555::aaa:bbb:ccc:ddd]:1357 | calling entity UE1 |
| From: <sip:user1_Public@home1.net> | Public identity SIP1 of |
| | calling party UE1 |
| To: <user2_Public@home2.net> | Public identity SIP2 of |
| | called party UE2 |
| Contact: | IP1 address of calling |
| <SIP;[5555::aaa:bbb:ccc:ddd]:1357> | entity UE1 to contact on |
| | return |
| Record - Route: | |
| <sip:scsf1.home1.net> | Address of the S-CSCF1, |
| <sip:pcsf1.visited.net> | Address of the P-CSCF1 |

At step E6 following step E5, if the session control server S-CSCF2bis does not have data relating to the user profile of the second equipment UE2, it download them from the database HSS2. The invitation received at step E5 by the control server S-CSCF2bis is stored in the latter. At step 6, the database HSS2 registers the name of the control server S-CSCF2 for the public identity SIP2 of the second equipment. Thus, all of the incoming sessions to the destination (To) of the public identity SIP2 of the second equipment UE2 will be routed to the control server S-CSCF2bis. Furthermore, this assures that the second equipment UE2 is registered then in this control server S-CSCF2bis.

The second equipment UE2, not being registered in the second nominal network IMS2, the control server S-CSCF2bis does not recognize the address IP2 of UE2, nor the proxy server P-CSCF in the network 2 for UE2.

The control server S-CSCF2bis transmits the invitation represented below to an appropriate session control proxy server P-CSCF of the domain IMS2, or to the session control proxy server P-CSCF2ter of the domain IMS2.

| | |
|---|---|
| Invite sip: | Public identity SIP2 of |
| user2_Public@home2.net SIP/2.0 | called entity UE2 |
| Via: | |
| SIP/2.0/UDP scscf2bis.home2.net, | Address of the S-CSCF2bis, |
| SIP/2.0/UDP icscf2.home2.net, | Address of the I-CSCF2, |
| SIP/2.0/UDP scscf1.home1.net, | Address of the S-CSCF1, |
| SIP/2.0/UDP pcsf1.visited.net, | Address of the P-CSCF1, |
| SIP/2.0/UDP | IP1 address of the |
| [5555::aaa:bbb:ccc:ddd):1357 | calling entity UE1 |
| From: <sip:user1_Public@home1.net> | Public identity SIP1 of |
| | calling party UE1 |
| To: <user2_Public@home2.net> | Public identity SIP2 of |
| | called party UE2 |
| Contact: | address IP1 of calling |
| <SIP;[5555::aaa:bbb:ccc:ddd]:1357> | entity UE1 to contact on |
| | return |
| Record - Route: | |
| <sip:scsf2bis.home2.net> | Address of the |
| | S-CSCF2bis, |
| <sip:scsf1.home1.net> | Address of the S-CSCF1, |
| <sip:pcscf1.visited.net> | Address of the P-CSCF1 |

When the proxy server P-CSCF2ter receives the invitation at the following step E7, it does not find an IP address in the Invite field of the invitation and looks in its own database for the IP address of the equipment UE2 associated with the public identity SIP2 present as the destination address in the Invite field of the invitation.

But, as the second equipment UE2 is not registered, no IP address is found for the second equipment UE2 by the proxy server P-CSCF2ter in its own database, which results in that the proxy server P-CSCF2ter detects a situation of incoming IMS session. In the event it detects an incoming IMS session, the invitation represented below is encapsulated by the proxy server P-CSCF2ter at step E7 in an IP packet whose IP header has as its IP destination address a specific pre-registered IP destination address, or IPS, which is that of the address resolution AR module of the nominal network IMS2 of UE2, for example.

The proxy server P-CSCF2ter sends this invitation in this packet at step E7 to any GGSN service transit node of the mobile telecommunications network 2 associated with UE2 but determined to be appropriate or to the transit node GGSN2ter of the mobile telecommunication network 2 associated with UE2. The proxy servers P-CSCF are configured in advance for sending the invitations that they receive to any one of a list of transit service nodes GGSN predetermined as supporting the signaling communications channel activation (signaling Context PDP) by the network. In order to do this, the GGSN transit service nodes of said list are those of a sufficiently evolved version, for example, later than version 5.

| | |
|---|---|
| Invite sip: | Public identity SIP2 of |
| user2_Public@home2.net SIP/2.0 | called entity UE2 |
| Via: | |
| SIP/2.0/UDP pcscf2ter.visited1.net, | Address of the |
| | P-CSCF2ter, |
| SIP/2.0/UDP scscf2bis.home2.net, | Address of the |
| | S-CSCF2bis, |
| SIP/2.0/UDP icscf2.home2.net, | Address of the I-CSCF2, |
| SIP/2.0/UDP scscf1.home1.net, | Address of the S-CSCF1, |
| SIP/2.0/UDP pcscf1.visited.net, | Address of the P-CSCF1, |
| SIP/2.0/UDP | IP1 address of the |
| [5555::aaa:bbb:ccc:ddd]:1357 | calling entity UE1 |
| From: | Public identity SIP1 of |
| <sip:user1_Public@home1.net> | calling party UE1 |
| To: <user2_Public@home2.net> | Public identity SIP2 of |
| | called party UE2 |
| Contact: | Address IP1 of calling |
| <SIP;[5555::aaa:bbb:ccc:ddd]:1357> | entity UE1 to contact on |
| | return |
| Record - Route: | |
| <sip:pcscf2ter.visited1.net> | Address of the |
| | P-CSCF2ter, |
| <sip:scscf2bis.home2.net> | Address of the |
| | S-CSCF2bis, |
| <sip:scscf1.home1.net> | Address of the S-CSCF1, |
| <sip:pcscf1.visited.net> | Address of the P-CSCF1 |

The GGSN2 service transit node of the second mobile telecommunications network 2 checks the following step E8, if there exists a second communications channel (PDP context) between it and a node SGSN node of the second mobile telecommunications network 2 for the IP address, which comes from the IP header of the packet encapsulating the invitation and which is IPS. Being given that no communications channel (Context PDP) exists for the second equipment UE2 in the network 2 (vide supra) for this IPS address, the node GGSN2 confirms this. This confirmation results in that the transit service node GGSN2:

extracts the public identity contained in the destination address (To) from the IP packet received from the invitation encapsulated in said IP packet, which is that of SIP2 of UE2;

interrogates the address resolution AR module in order to ask it what is the number IMSI corresponding to the address SIP2 of the second equipment UE2 having been extracted;

This address resolution AR module is present in the mobile telecommunications network 2 associated with the second equipment UE2 and is functionally distinct from the services subscription database HSS2. In this address resolution AR module, mobile telecommunications equipment of the second mobile telecommunications network 2 and their private identity, and thus the public address SIP2 and the number IMSI2, associated with the second equipment UE2, are registered permanently in association with the public addresses (at least those SIP addresses and possibly the IP addresses where the IP addresses are contained).

The AR module having received from the node GGSN2 the aforementioned interrogation, it sends to said latter the number IMSI associated with the address SIP2 present in said interrogation; that is, the number IMSI2.

At the following step E9, the GGSN2 service transit node queries the subscriptions database HSS2, via an interface Gc, for the IP address of the SGSN service support node of the second mobile telecommunications network 2, which serves the equipment UE2 having the IMSI2 identification number. The subscription database HSS2 then responds to the GGSN2 service transit node, via Gc, by the IP address of the service support node SGSN2 of the second mobile telecommunications network that serves the equipment UE2 having the IMSI2 identification number, the association between this IP address of the node SGSN2 and the number IMSI2 being pre-registered in the database HSS2 at the time of the prior attachment procedure of the equipment UE2. Step E9 is carried out using the MAP procedures.

Then, at the time of step E10, the GGSN2 service transit node sends to the IP address of the SGSN2 node, having communicated with it at step E9, an incoming packet notification by stating that it is a signaling communications channel (signaling Context PDP), said notification being, for example, a PDU notification message. This PDU notification message contains the IMSI2 number of UE2, an empty IP address field, the name of the corresponding APN access point and an IMCN field set to 1 in order to indicate that it is a signally channel. The IP address field is empty, being given that the IP address of UE2 is unknown and so that dynamic IP address allocation is done.

At the following step E11, he SGSN2 support service node sends to the GGSN2 service transit node a response to the incoming packet notification, in order to indicate to it that the operation is progressing, said response being a PDU notification response message (PDU Notification Response).

At the following step E12, the SGSN2 service support node asks the second equipment UE2 to request (Request PDP Context Activation) a signaling communication channel activation (signaling Context PDP).

At the following step E13, the second equipment UE2, having received from the SGSN2 service support node the query to request a signaling communications channel activation, sends an signaling communications channel activation request (PDP context Activation Request) to said SGSN2 service support node.

In the signaling communications channel activation request, the second equipment UE2 requests the dynamic allocation of an IP address by setting a corresponding “PDP address” field to zero. The equipment UE2 sends within this message the APN transmitted by the SGSN2 at the preceding step.

In response, the SGSN2 service support node selects a GGSN transit service node of the network 2, which may be different or identical to the GGSN2 node and which is designated by the reference GGSN2bis, and proceeds with the creation of the signaling communications channel (Context PDP) with the GGSN2bis transit service node of the network 2. After creating the signaling communications channel, the SGSN2 service support node sends to the equipment UE2 a communications channel activation acceptance message (Activate PDP Context Accept), which contains the IP address allocated to UE2, or IP2bis. This communications channel (Context PDP) will be used for the IMS signaling.

Then the second equipment UE2 is registered with the nominal network IMS2 in the following fashion.

The procedure for discovering the P-CSCF session control proxy server of the second nominal network IMS2, described hereinbefore, is implemented for UE2 using the GGSN2bis transit service node of the second mobile telecommunications network 2, which results in the discovery of a session control proxy server P-CSCF2bis of the second nominal network IMS2, identical to or different from the session control proxy server P-CSCF2 of the second nominal network IMS2.

Then the procedure for registering the second equipment UE is implemented in the second nominal network IMS2 by utilizing the identity of UE2. Being given that the subscriptions database HSS2 of the second nominal network IMS2 registered—at the time of the aforementioned step E6 (vide supra)—the identifier of the session control server S-CSCF2 serving said second equipment UE2 in association with its public identity SIP2, the request for registration is automatically transmitted to this same session control server S-CSCF2 of the second nominal network IMS2. Consequently, the second equipment UE2 will be registered by its identity or identities, according to the registration procedure described hereinbefore, in the second nominal network IMS2 in the database HSS2 and the session control server S-CSCF2, which will then register as sending proxy server P-CSCF the sessions control proxy server P-CSCF2bis, which will recognize the address IP2bis of the second equipment UE2 by having registered it.

When it receives this registration request, the session control server S-CSCF2 checks if the identity SIP2 of the second equipment UE2 present in the registration request is also present in its registration table.

Begin given that the second equipment UE2 has been registered in the domain IMS2, the address SIP2 of this second equipment UE2 is already registered in the registration table of the session control server S-CSCF2 and consequently the result of the check is that the identity SIP2 of the second equipment UE2 present in the request for registration is also present in its registration table. It follows that the session control server S-CSCF2 checks if there exists an invitation that it has kept stored at step E6 for the identity SIP2 of the second equipment UE2, and is present in the request for registration and if, for said stored invitation, the session control server S-CSCF2 has not received an OK messaged from the second equipment UE2. If this is the case, the session control server S-CSCF2 sends the stored invitation to the second equipment UE2 pursuant to the characteristics obtained at the time of the second registration procedure, via the transit service node P-CSCF2bis, the service node GGSN2bis and the service support node SGSN2.

The session will then be established.

1. A method for establishing a multimedia session between a caller telecommunications equipment and a called equipment which is a mobile equipment of a multimedia sub-domain network, wherein:
an invitation (Invite) is sent from the first user equipment (UE1) to establish a multimedia session, which comprises as he destination address a public identity of the second equipment, said invitation being transmitted:
by the first equipment (UE1) to a first proxy server (P-CSCF1), then,
from this first proxy server, to a first session control server (S-CSCF1) of the network in which the first equipment (UE1) is registered, and
from this first session server (S-CSCF1) to a point of entry server (I-CSCF2) of the network corresponding to the destination address of the second equipment (UE2);
this point of entry server (I-CSCF2) interrogates a database (HSS2) of the network of the second equipment (UE2) in order to obtain the address of a session control server (S-CSF2) responsible for said second equipment (UE2);
when said second equipment (UE2) is registered in said database:
said point of entry server (I-CSCF2) transmits the invitation message to the selected session server (S-CSCF2), and
said session server (S-CSCF2) transmits the invitation message to a proxy server (P-CSCF2) corresponding to the second equipment,
wherein
the proxy server (P-CSCF2) transmits this invitation message by encapsulating it in an IP packet to the second equipment via an appropriate transit node (GGSN).

2. The method according to claim 1, wherein:
the transit node (GGSN) interrogates an address resolution (AR) database for converting the public identity of the second equipment into an international subscriber identification number (IMSI) and for determining if said second equipment (UE2) has an active signaling communications channel (PDP Context), then interrogates the database HSS, in order to determine as a function of this identification number (IMSI) the address of a service node (SSGN) serving said second equipment (UE2);
the transit node (GGSN) transmits to said service node (SGSN), on which the second equipment depends, a signaling request for activation of the multimedia communication channel (PDP context);
said service node (SGSN), on which the second equipment depends, sends this request to the second equipment (UE2)

3. The method according to one of claims 1 or 2, wherein, when the point of entry server (I-CSCF2) questions the database (HSS2) of the network of the second equipment, in order to determine the session control server (S-CSCF2) responsible for it and when the public identity of said second equipment (UE2) is not registered in said database, said point of entry server (I-CSCF2) selects a session control server from among a plurality of possible servers and transmits to it the invitation message.

4. The method according to claim 3, wherein the second server (S-CSCF2) is registered on the database as being the session control server associated with the second mobile equipment.

5. The method according to claim 4, wherein, when the second session control server (S-CSCF2) receives the invitation message and the database (HSS2) does not contain any correspondence between the public identity of the second equipment and an address on the network, the session control server selects a proxy server from among a plurality of possible servers.

6. The method according to claim 5, wherein, when the second proxy server (P-CSCF2) receives the invitation message and the database (HSS2) does not contain any correspondence between the public identity of the second equipment and an address on the network, said proxy server (P-CSCF2) then selects a transit node (GGSN) in the network of the second equipment, in order to transmit to it the IP packet, by giving it a specific address corresponding to said node.

7. The method according to claim 6, wherein the specific address is that of the address resolution database.

8. The method according to claim 6, wherein, when the transit node (GGSN) receives this IP packet and it detects this specific address, it interrogates an address resolution (AR) database, in order to obtain the international subscriber identification number (IMSI) of the second equipment as a function of the call control signaling identity (SIP) transmitted with the invitation message,
said transit node (GGSN) interrogating the network database (HSS2) in order to determine as a function of this identification number (IMSI) the address of the service node (SGSN) serving said second equipment (UE2);
the transit node (GGSN) transmits to said service node, on which the second equipment (SGSN) depends, a signaling request (PDP Context) for multimedia communications channel activation;
said service node (SGSN), on which the second equipment depends, sends this request to the second equipment (UE2).

9. The method according to claim 7, wherein, when the address resolution database receives the IP packet, it sends to the transit node (GGSN), to which it corresponds, the international subscriber identification number (IMSI) of the second equipment, which is a function of the identity of the call control signaling (SIP) transmitted with the invitation message,
said transit node (GGSN) interrogates the database (HSS2) of the network, in order to determine as a function of this identification number (IMSI) the address of the service node (SGSN) serving said second equipment (UE2);
the transit node (GGSN) transmits to said service node, on which the second equipment (SGSN) depends, a signaling request (PDP Context) for multimedia communications channel activation;
said service node (SGSN), on which the second equipment depends, send this request to the second equipment (UE2).

10. The method according to one of the above claims, wherein:
the second equipment (UE2) activates, with a transit node possibly different from the first transit node, a multimedia communications procedure corresponding to the request it received;
wherein:
the second equipment (UE2) continues the procedure by discovering a proxy server (P-CSCF2′), corresponding possibly to the second proxy server, then by registering itself of re-registering itself with the second session control server (S-CSCF2), said latter verifying the acknowledgement of the invitation messages addressed to the second equipment (UE2) and re-transmitting any invitation message not acknowledged to the second equipment (UE2) conforming to the last registration received and requesting, if necessary, the former second proxy server (P-CSCF2) to cancel any request in progress.

11. The method according to one of the above claims, wherein the network is of the UMTS type.

12. A communications system enabling the establishment of a multimedia session between a calling telecommunications equipment and a called telecommunications equipment that is a mobile equipment of a multimedia sub-domain type network, wherein the calling or called equipment(s) and/or the proxy server(s) and/or the session server(s) and/or the point of entry server(s) and/or the service nodes comprise processing means for implementing the method according to one of the above claims.

13. The system according to claim 12, wherein the network comprises at least one session control server that, for implementing the method according to claim 5, comprises memory means, in which the addresses of the proxy servers are stored.
